(19) United States
(12) Patent Application Publication
(10) Pub. No.: US 2010/0123780 A1
(43) Pub. Date: May 20, 2010

(54) METHOD AND DEVICE FOR MONITORING A PRINTED IMAGE ON A MOVING MATERIAL WEB

(76) Inventor: Michael Wiebe, Leopoldshohe (DE)

Correspondence Address: KLEIN, O'NEILL & SINGH, LLP, 43 CORPORATE PARK, SUITE 204, IRVINE, CA, 92606, US

(21) Appl. No.: 12/620,284

(22) Filed: Nov. 17, 2009

(30) Foreign Application Priority Data
Nov. 18, 2008 (DE) 10 2008 057 891.6

(51) Int. Cl. H04N 7/18; G06K 9/00

(52) U.S. Cl. 348/160; 382/112; 348/E07.085

(57) ABSTRACT

A method for monitoring a printed image on a moving material web uses a camera to record the printed image. The recorded image is displayed on a monitor. A partial area of the printed image to be monitored is selected by means of an electronic control from an area of a virtual target image or the recorded image. The physical printed image recorded by the camera is stored in a memory and continually renewed on section-wise basis. The recorded image is renewed while the monitor displays a selected partial area of the printed image stored in the memory.

### CROSS-REFERENCE TO RELATED APPLICATION

This application claims priority to German patent application DE 10 2008 057 891.6 filed Nov. 18, 2008, the contents of which are expressly incorporated herein by reference as if set forth in full.

### BACKGROUND

This disclosure relates to monitoring printed images and, more particularly, to a printed image on a moving material web.

Monitoring a printed image on a moving material web has been performed using an electronic camera, where the image recorded by the camera is displayed on a monitor and compared with a preset survey image or target image stored in a memory. At the target image, a partial area is selected for monitoring. In response to the selection, the camera is moved into the corresponding position over the physical printed image. The selected partial area at the target image may be enlarged for monitoring purposes. In response, the zoom of the camera is adjusted correspondingly so that the image of the printed image recorded by the camera is displayed on the monitor with the same degree of enlargement as previously set at the target image.

In this method of monitoring a printed image, displacing the camera to the selected partial area over the physical printed image and setting the zoom of the camera requires an amount of time. For example, in the case of a material web approximately two meters wide, if a partial area of the printed image extending over the width of the material web is to be monitored on the right side, the camera is net to this partial area. Then, when a partial area is to be monitored on the left side of the printed image, the camera must be moved or displaced over the two-meter-wide material web, for which a certain amount of time is required. Thus the images on the right and left side of the printed web can only be prepared for monitoring with a corresponding time interval.

### SUMMARY

The preferred embodiments of the present methods, apparatus, systems, and components for monitoring a printed image on a moving material web have several features, no single one of which is solely responsible for their desirable attributes. Without limiting the scope of the present embodiments as expressed by the claims that follow, their more prominent features now will be discussed briefly. After considering this discussion, and particularly after reading the section entitled “DETAILED DESCRIPTION”, one will understand how the features of the present embodiments provide advantages.

In one aspect, the invention provides a method for monitoring a printed image on a moving material web, the method including capturing images of partial areas of a moving material web having printed images; storing the captured images in a memory to form a continuously renewed image of the printed images; and displaying at least part of the continuously renewed image.

In another apect, the invention provides a device for monitoring an image printed on a moving material web, the device including: a camera configured to capture images of partial areas of the printed image; a memory coupled to the camera and configured to store the captured images; a control and calculation unit coupled to the camera and configured to control movement of the camera transverse to the material web, where the control and calculation unit replaces partial areas of the image stored in the memory continuously with corresponding newly captured partial areas; and a monitor for displaying the printed image from the memory, where the monitor is configured to display the printed image independently of the movement of the camera and independently of the replacement of partial areas of the image in the memory.

### BRIEF DESCRIPTION OF THE DRAWINGS

Exemplary embodiments of the invention are explained in more detail below with reference to the drawings, in which:

FIG. 1 is a block diagram of a system for monitoring a printed image on a moving material web in accordance with aspects of the invention;

FIG. 2A is an exemplary monitor display of a target image in accordance with aspects of the invention;

FIG. 2B is a diagram of an exemplary printed image on a moving material web in accordance with aspects of the invention;

FIG. 3 is a further exemplary monitor display of a target image in accordance with aspects of the invention; and

FIG. 4 is a diagram of camera and exemplary printed images on a moving material web in accordance with aspects of the invention.

### DETAILED DESCRIPTION

The detailed description set forth below in connection with the appended drawings is intended as a description of the presently preferred embodiments of methods, apparatus, systems and components for monitoring a printed image on a moving material web thereof provided in accordance with aspects of the present invention and is not intended to represent the only forms in which the present invention may be constructed or utilized. The description sets forth the features and the steps for constructing and using the methods, apparatus, systems and components for monitoring a printed image on a moving material web of the present invention in connection with the illustrated embodiments. It is to be understood, however, that the same or equivalent functions and structures may be accomplished by different embodiments that are also intended to be encompassed within the spirit and scope of the invention. As denoted elsewhere herein, like element numbers are intended to indicate like or similar elements or features.

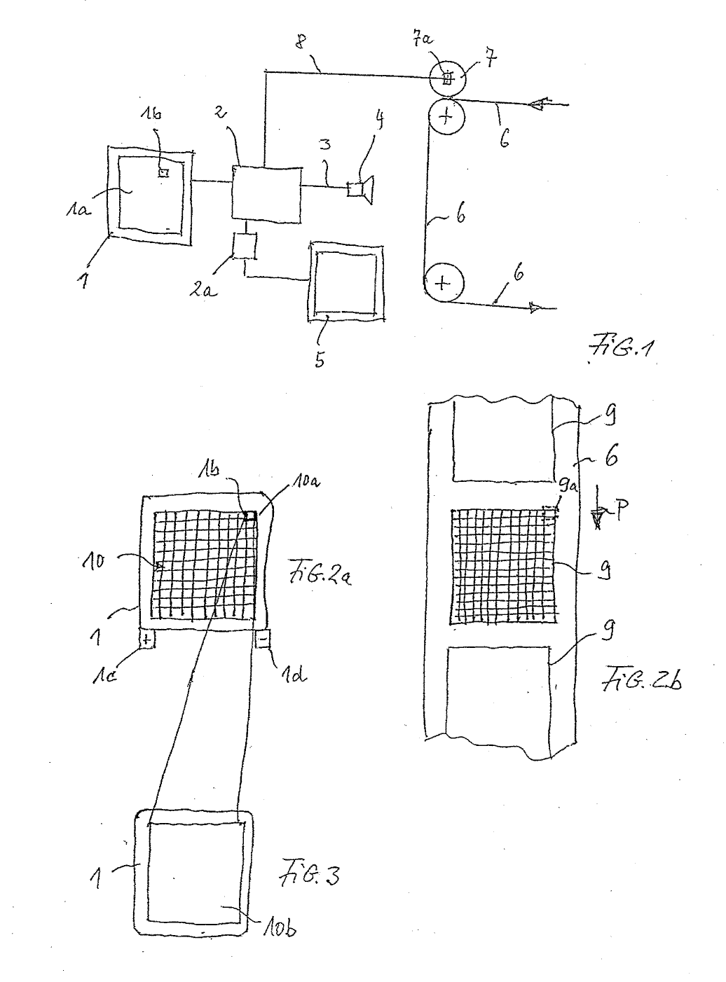

FIG. 1 is a block diagram of a system for monitoring a printed image on a moving material web in accordance with aspects of the invention. The system includes a first monitor 1 that displays a survey image corresponding to a printed image, which may be a target image, a sample image, or an image for reviewing. The first monitor may be a touch screen display. The first monitor 1 includes a display screen 1a that may display the whole target image or a partial area of the target image. The partial area may be selected using a cursor 1b. The system includes a control and calculation unit 2 that is coupled to the first monitor 1. A camera 4 is also included in the system. The camera 4 may be, for example, a video camera or a line-scan camera. The control and calculation unit 2 is coupled to the camera 4 by a line 3 to control arrangement of the camera 4 before a moving material web 6 to capture images of the moving material web 6. The system includes a printing cylinder 7 that prints images on a material web 6. The printing cylinder 7 is part of a printing machine. A position sensor 7a is located at the printing cylinder 7 to provide signals as to the running speed or position of the material web 6. The position sensor 7a may be an incremental encoder. Signals from the position sensor 7a are coupled to the control and calculation unit 2 by way of a line 8.

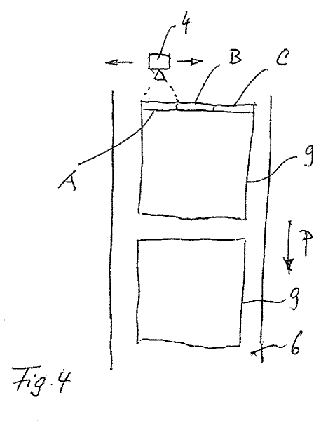

FIG. 2A is an exemplary monitor display of a target image. FIG. 2B is a diagram of an exemplary printed image on a moving material web. A virtual target image 10 is illustrated with a grid structure. The virtual target image 10 is displayed on the first monitor 1 and corresponds to a physical printed image 9 on the moving material web 6.

The target image 10 on the monitor 1 is a high-resolution virtual image of the printed image 9. The virtual target image 10 may be obtained, for example, as a digital file created in a pre-print stage (design area) of the printing machine or by a camera.

The printed images 9 are printed one after another on the material web 6 by the printing cylinder 7. An arrow P shows the direction of movement of the material web 6. The cursor 1b may be navigated to a partial area of the target image 10 that is to be monitored for printing quality. A control means, for example a mouse, is used to navigate the cursor. As illustrated in FIG. 2A, the cursor 1b is displaced, for example, into the upper right corner 10a of the target image 10, corresponding to the partial area of the physical printed image 9 shown by dashed lines 9a in FIG. 2B.

The control and calculation unit 2 is coupled to a memory 2a, in which a captured version of the whole printed image 9 is stored or portions thereof. The stored image is recorded by the camera 4 section-wise or by partial areas. The camera 4 may be moved on a traversing unit transverse to the moving material web 6. This allows a web width larger than the field of view of the camera to be captured. By continual section-wise capturing of the printed image 9 by the camera 4, the whole printed image 9 is stored in the memory 2a. That is, the stored image is renewed section-wise in an on-going manner. Thus the image stored in the memory 2a is composed of individual sections or partial areas that are renewed by the camera 4 in an on-going manner.

FIG. 4 is a diagram of camera and exemplary printed images on a moving material web. As shown, the camera 4 is displaceable over the width of the material web 6 by the traversing unit, for example, by an electric driving motor, whereby the camera 4 can be moved back and forth transverse to the material web 6 by the traversing unit, as indicated by arrows. Initially, the camera 4 is directed to a partial area A of the printed image 9 and that area is recorded. After recording the partial area A, the camera 4 is displaced to the right, whereupon a partial area B and then a partial area C are recorded. During the backwards movement of the camera from right to left from the perspective of FIG. 4, again a partial area C, then a partial area B and a partial area A are recorded, wherein in the meantime the material web 6 has moved in the direction of arrow P so that the second recorded partial area C is displaced relative to the first recorded partial area C. The partial areas may be displaced wholly or partially overlapping. In this way, the whole printed image 9 composed of sections or partial areas A, B and C is continually renewed section-wise.

In an embodiment where the camera 4 is a line-scan camera, a partial area A corresponds to a section of a line of the printed image 9, which consists of partial areas A, B and C.

The first monitor 1 displaying the virtual target image 10 is connected to the memory 2a by means of the control and calculation unit 2 such that a partial area of the whole image stored in the memory and renewed continually section-wise by camera 4 is selected at the target image 10 (as shown in FIG. 2A, top right) and displayed, for example, on a second monitor 5, so that quality control can be performed in relation to the target requirement on the virtual target image 10. Subsequently, when a partial area of the printed image on the left side of the (for example) two-meter-wide printed image 9 is to be monitored, a partial area on the left side in FIG. 2A is selected on the first monitor 1 by means of the cursor 1b. Via the control and calculation unit 2, this partial area is displayed on the second monitor 5 as a corresponding partial area of the whole image stored in the memory 2a. This change from the right side of the printed image to the left side of the printed image can be performed very quickly by displacing the cursor 1b. The displaying of the selected partial area on the left side of the printed image in the monitor 5 takes place correspondingly quickly as the image displayed on the second monitor 5 corresponds to the partial area of the whole image stored in the memory 2a.

During the selection process from the right to the left side in the target image 10, the camera 4 can move in a different area of the physical printed image, for example, from left to right in the lowest line, to renew the lower partial areas of the physical printed image 9 in the memory 2a. In other words, the movement of the camera 4 is controlled independently of the selection process of the partial areas at the target image 10, because these partial areas are taken from the memory 2a for quality control and the whole printed image continually being renewed section-wise. Thus, the monitoring of printing quality can be performed very quickly. In some embodiments, the partial area recalled from the memory 2a does not simultaneously display on the second monitor 5, nevertheless a largely up-to-date display of the physical printed image 9 is available for quality control, due to the continual section-wise renewal of the image stored in the memory 2a.

The stored image in the memory 2a of the printed image may be digitally zoomed or otherwise processed without the camera 4 having to be moved. Thus, every detail of the printed image 9 can be displayed on the second monitor 5 very quickly.

In one embodiment, the camera 4 is a CCD or CMOS camera and only images sections A, B, and C and so on of the physical printed image 9. In one embodiment, the camera 4 is able to capture the whole physical printed image 9, but the resolution of the printed image is relatively low. By capturing individual sections like A, B, and C of the printed image 9, correspondingly higher resolution can be achieved. Thus, an aspect the present environment is understood to include an apparatus or system for upscaling an image by capturing individual sections of the image on a moving material web.

The camera 4 is a line-scan camera in some embodiments. The camera 4 then yields a one-dimensional image in line form. The line-scan camera achieves advantages of lighting. When using a surface area camera with total reflection from the physical printed image 9, the surface area camera must be positioned inclined in order to be focussed on the related section of the printed image 9. Whereas, a line-scan camera can be pivoted randomly without a focusing problem.

When using a line-scan camera for a physical printed image 9 of, for example 1000×1000 pixels, only one section of, for example, 100 pixels is captured, wherein 100×1000 pixels can be captured by means of the rotation of the printing cylinder 7 running the material web 6 before the fixed camera 4. In contrast, in the case of a surface area camera (matrix camera), for such a printed image of 1000×1000 pixels, a section A of, for example, 100×100 pixels would be captured.

By using a line scan camera, a section-wise renewal of the image of the whole printed image stored in the memory 2a may be performed within a few seconds, depending on the rotation speed of the printing cylinder 7.

An operator is able to monitor in a short time exactly the area of a printed image selected by the operator for printing quality control. The position or zoom of the camera 4 is not modified base on the selected area.

Using an electronic selection device, for example, a mouse, the operator can select a random area of the printed image in the memory 2a and enlarge the area as required, while the camera 4 captures other areas of the physical printed image 9 and renews these areas in the memory 2a.

The area of the target image 10 selected by the cursor 1b in FIG. 2A can be adjusted by means of an enlargement switch 1c to an enlargement that is expedient for printing quality control. FIG. 3 illustrates the partial area selected at the target image 10 by the cursor 1b enlarged such that the enlarged area 10b takes up the whole display screen of the first monitor 1. As an example, the target image 10 in FIG. 2A may represent a printed image to be manufactured for a block of stamps with, for example, an array of 50 stamps in width and 50 stamps in length forming the physical printed image 9. The area selected by the cursor 1b may be, for example, a single stamp at 10a in the top right corner of the target image 10, where by way of the enlargement switch 1c, enlargement of this single stamp is performed such that the stamp takes up the whole area of the display screen 1a, as shown in FIG. 3. As this enlargement is performed at a partial area of the printed image stored in the memory 2a, the camera 4 is not affected by this enlargement process.

A size-reduction switch 1d is provided in some embodiments for reducing the selected area 10b in size on the first monitor 1, so that, for example, it is possible to adjust from too great of enlargement to a lesser degree of enlargement at the target image 10.

In other embodiments, instead of a size-reduction switch 1d, a switch or press button is provided by which the selected enlargement can be adjusted to the original target image 10 without an enlargement. An enlargement of a determined area can then be performed starting from the target image 10 giving a complete overview.

In some embodiments, instead of a first monitor 1 and a second monitor 5, the system uses a single monitor on which the virtual target image 10 and, by switching to the recording of the physical printed image 9, the stored image from the memory 2a can be displayed. The display screen of the single monitor may also be divided such that the target image 10 is displayed simultaneously on the display screen adjacent the area of the printed image selected from the memory.

When using the device shown in FIG. 1, the printed image stored in the memory 2a, which is continually renewed section-wise, may also be displaced on the first monitor 1 in a total view, wherein this total view on the first monitor 1 serves as a navigation aid for the selection of a partial area by 1b, which is then displayed at high resolution on the second monitor 5, on which the operator monitors the printing quality without performing a comparison with a virtual target image 10.

In the method according to the invention, for monitoring a printed image 9 on a moving material web 6 by means of a camera 4, the printed image recorded by the camera is displayed on a monitor 1, 5, and a partial area 1b of the printed image is selected by means of an electronic control means for monitoring at a virtual target image 10 or at the printed image recorded by the camera 4, wherein the physical printed image 9 recorded by the camera 4 is stored in the memory 2a and continually renewed section-wise, while a selected partial area 1b of the printed image stored in the memory 2a can be reproduced at the monitor 5 for monitoring independently of the recording of partial areas A, B, C by the camera 4 and independently of the on-going section-wise renewal of the stored printed image.

Although the present invention has been described with reference to specific embodiments, these embodiments are illustrative only and not limiting. Many other applications and embodiments will be apparent in light of this disclosure and the following claims.

What is claimed is:

1. A method for monitoring a printed image on a moving material web, the method comprising:
capturing images of partial areas of a moving material web having printed images;
storing the captured images in a memory to form a continuously renewed image of the printed images; and
displaying at least part of the continuously renewed image.

2. The method of claim 1, wherein the displaying at least part of the continuously renewed image comprises displaying a selected partial area of the printed image.

3. The method of claim 2, wherein the displaying a selected partial area of the printed image is performed independently of the capturing images.

4. The method of claim 1, further comprising displaying a target image.

5. The method of claim 4, wherein the displaying at least part of the continuously renewed image and the displaying a target image are concurrent.

6. The method of claim 4, wherein the displaying at least part of the continuously renewed image and the displaying a target image utilize a single monitor.

7. The method of claim 4, wherein the displaying at least part of the continuously renewed image utilizes a first monitor and the displaying a target image utilizes a second monitor.

8. A device for monitoring an image printed on a moving material web, the device comprising:
a camera configured to capture images of partial areas of the printed image;
a memory coupled to the camera and configured to store the captured images;
a control and calculation unit coupled to the camera and configured to control movement of the camera transverse to the material web, where the control and calculation unit replaces partial areas of the image stored in the memory continuously with corresponding newly captured partial areas; and
a monitor for displaying the printed image from the memory, where the monitor is configured to display the printed image independently of the movement of the camera and independently of the replacement of partial areas of the image in the memory.

9. The device of claim 8, wherein the camera is a line-scan camera.
